(19) United States
(12) Patent Application Publication
(10) Pub. No.: US 2006/0230144 A1
(43) Pub. Date: Oct. 12, 2006

(54) Method and apparatus for relieving pressure during peak-usage times

(76) Inventor: Anil Rajaram Shah, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/981,247

(22) Filed: Nov. 4, 2004

(51) Int. Cl. G06F 15/16; G06F 15/173

(52) U.S. Cl. 709/225; 709/223; 709/224; 709/219

(57) ABSTRACT

One embodiment disclosed relates to a method of relieving pressure during peak-usage times of an online system. Current usage of the system is monitored, and a determination is made as to whether the current usage is above a pre-determined threshold level. If the usage is above the threshold, then an offer is provided to a current user with an incentive to use the system during a future off-peak window. Other embodiments are also disclosed.

### FIELD OF THE INVENTION

The present disclosure relates generally to computer software, and more particularly, to software for computer servers.

### DESCRIPTION OF THE BACKGROUND ART

User traffic at commercial websites can vary substantially depending on the time of day and seasonal factors. For example, a business-to-business website may be busiest during certain business hours of a weekday, and less busy during lunch time or during off hours; a business-to-consumer website may see substantially increased user traffic in the period leading up to the winter holiday season; a flower delivery website may see much increased traffic on a holiday like Mother's Day and the days immediately preceding such holidays; etc.

A problem faced by many such commercial websites is that it is difficult to find a cost-efficient way to meet desired performance metrics or services levels under a heavy traffic without investing heavily on the additional hardware resources that are idling most of the time. Poor performance can lead to loss of customers to other websites.

Hence, it is highly desirable to improve the performance of commercial websites during periods of high traffic in a cost-efficient manner.

### SUMMARY

One embodiment of the invention pertains to a method of relieving pressure during peak-usage times of an online system. Current usage of the system is monitored, and a determination is made as to whether the current usage is above a pre-determined threshold level. If the usage is above the threshold level, then an offer is provided to a current user with an incentive to use the system during a future off-peak window.

Another embodiment pertains to a system of relieving pressure during peak-usage times of a web site. At least one server is configured to host the web site. A historical usage database is coupled to the server and used for determining future off-peak windows. Computer-executable code is configured to monitor current usage of the web site and to determine if the current usage is above a pre-determined threshold level. In addition, computer-executable code is configured to present an offer to a current user with an incentive to use the system during a future off-peak window if the current usage is above the threshold level.

Other embodiments are also disclosed.

### BRIEF DESCRIPTION OF THE DRAWINGS

FIG. 1 is a graph depicting a hypothetical usage pattern of a system.

FIG. 2 is a schematic diagram of a system configured to serve end users in accordance with an embodiment of the invention.

FIG. 3 is a flow chart depicting a process for utilizing historical usage data in accordance with an embodiment of the invention.

FIG. 4 is a flow chart depicting a method of relieving pressure during peak-usage times in accordance with an embodiment of the invention.

FIG. 5 is a flow chart depicting a method of targeting an incentive deal in accordance with an embodiment of the invention.

### DETAILED DESCRIPTION

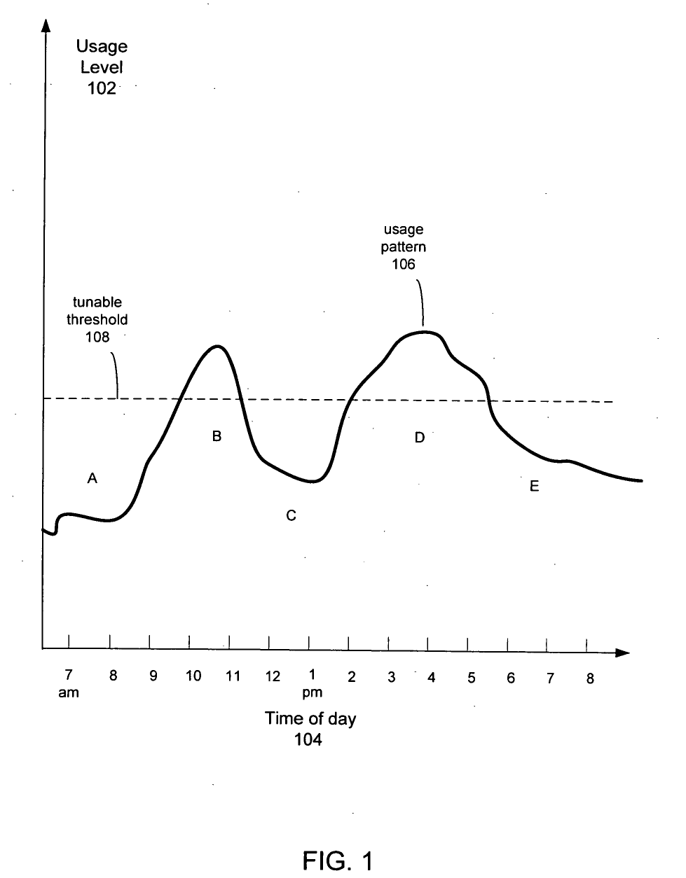

FIG. 1 is a graph depicting a hypothetical usage pattern of a system. The graph depicts the usage level 102 as a function of time 104 during a week day for a hypothetical system. As an exemplary embodiment, the system may be an online shopping server through which users may order products. In other embodiments, the system may comprise another type of apparatus which has a usage pattern.

Consider the hypothetical usage pattern 106 shown in FIG. 1 to be a typical or average usage pattern for a normal (non-holiday) weekday for the system. In this illustrative example, there are peak usage periods B and D in the mid-morning and mid-afternoon time periods. Off-peak usage periods include one in the early morning A, one around lunch time C, and one starting in the early evening E.

A tunable threshold level 108 is also shown. The use of such a threshold level 108 will be discussed further below.

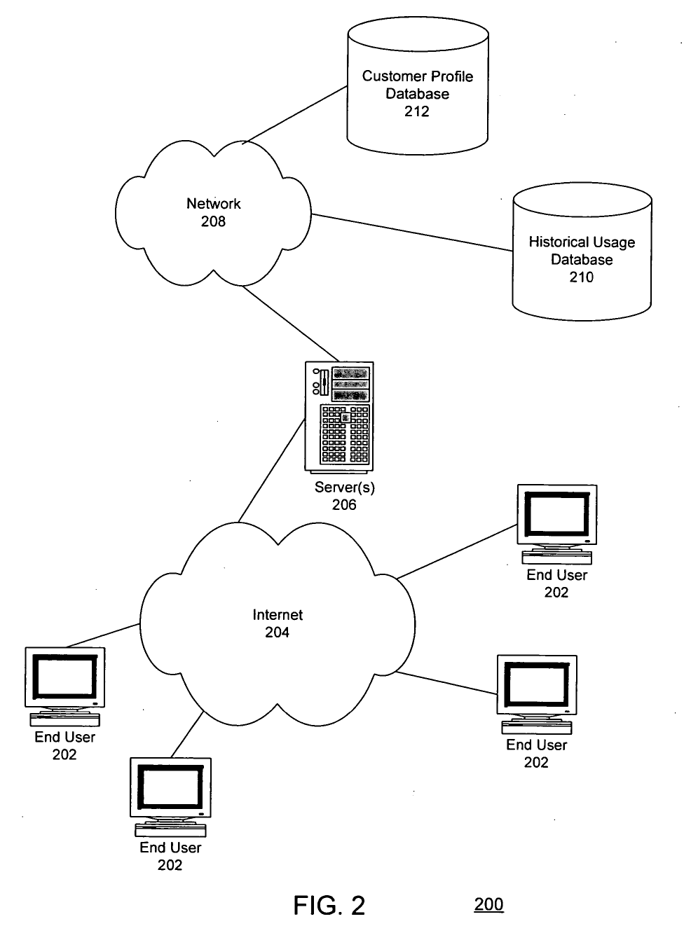

FIG. 2 is a schematic diagram of a system 200 configured to serve end users in accordance with an embodiment of the invention. As shown, the system 200 may include one or more end-user hosts 202 interconnected via the Internet 204 to one or more server(s) 206. In an embodiment, the server or servers 206 may comprise an online shopping server or servers. Such an online shopping server may be configured to provide a shopping web site such that end users may browse and order products.

In accordance with an embodiment of the invention, the server(s) 206 may have access to various databases via a network 208. The databases may include a historical usage database 210 and a customer profile database 212. The historical usage database 210 may be configured to track usage-related information, such as, for example, the number of users accessing the server(s) 206, or the number of orders being made through the server(s) 206, or other usage measures. The customer profile database 212 may be configured to track and store various information about existing customers, including, for example, their name, shipping address(es), payment methods, items previously ordered, dates and times of their orders, and other information.

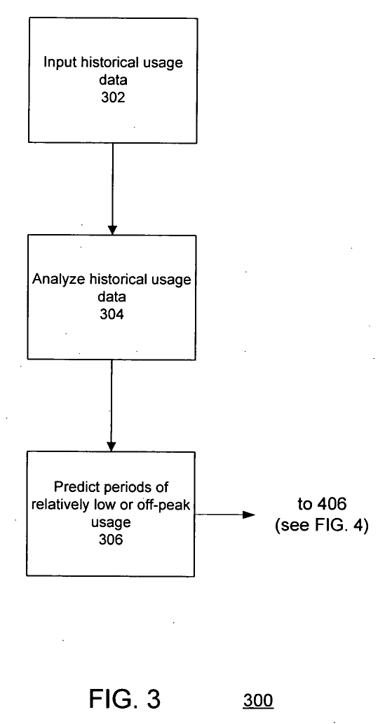

FIG. 3 is a flow chart depicting a process 300 for utilizing historical usage data in accordance with an embodiment of the invention. One or more components (for example, software or computer-executable code on one or more server 206) of the system 200 monitors use of the server(s) 206 and stores the usage data, for example, in a historical usage database 210.

Such historical usage data is input (302) into the processing system. The historical usage data is analyzed (304) to predict (306) upcoming periods of low or off-peak usage. For example, if the historical usage data for similar days averaged to the usage pattern 106 shown in FIG. 1, then the analysis may predict that upcoming off-peak periods for the day at issue includes the periods marked A, C, and E.

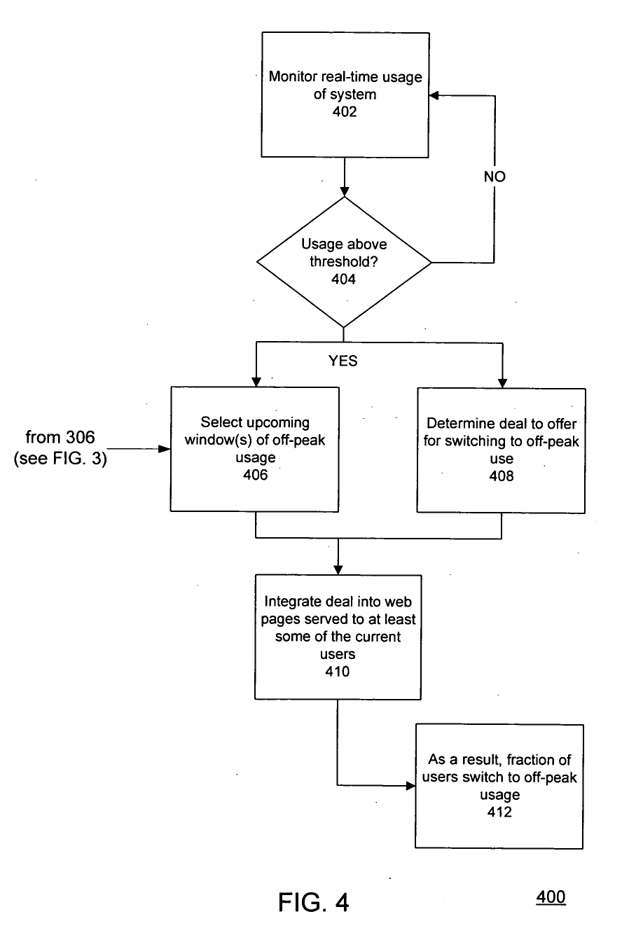

FIG. 4 is a flow chart depicting a method 400 of relieving pressure during peak-usage times in accordance with an embodiment of the invention. The usage of the commercial website system is monitored (402) in real-time or nearly real-time. The system usage may be monitored or determined based on, for example, the number of users accessing the server(s) 206, or the number of orders being made through the server(s) 206, or other usage measures.

Based on the monitoring, a determination (404) is made as to whether the usage of the system 200 goes above a threshold usage level. An example threshold usage level 108 is shown in FIG. 1 for purposes of illustration. The threshold level may be tunable so as to adjust under what circumstances the pressure relief mechanism kicks in. If the usage level is below the threshold, the method 400 continues to monitor (402) the real-time usage and to compare (404) that usage with the threshold. The threshold 108 may be selected, for example, based on the known capacity level for the server(s) 206. For instance, the threshold 108 may be set at 80% of the capacity, so that users are able to be incentivized to switch to an off-peak window prior to noticeable degradation in the performance of the system 200.

If the usage level is above the threshold, the method 400 proceeds with the pressure relief mechanism. In accordance with an embodiment of the invention, the pressure relief mechanism comprises an incentive-based mechanism for diverting users to off-peak periods.

An upcoming window or windows of off-peak usage is selected (406). The information about the upcoming off-peak periods may be obtained from the process 300 discussed above in relation to FIG. 3. The selection of windows (406) may be done in a way so as to spread out the user traffic from the “on-peak” period to one or more of the off-peak periods. If the user is an existing customer, then the window(s) presented to that user may be targeted based on data about previous activity (for example, previous purchases and/or browsing) by that user (which may be stored, for example, in a customer profile database 212).

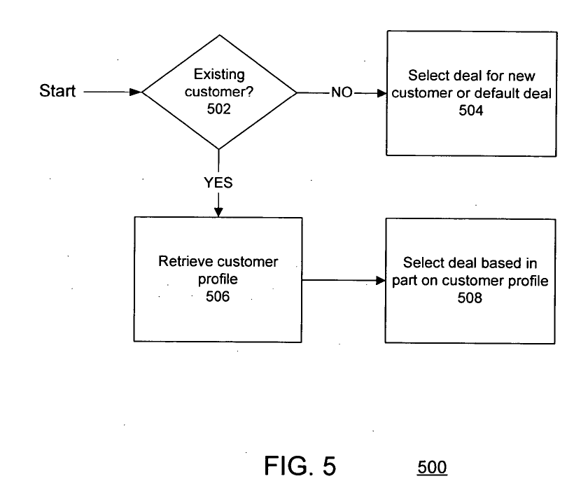

In addition, a determination (408) is made as to the deal or deals to offer users in order to provide incentive for them to switch to off-peak use. One technique for making the determination (408) is discussed below in relation to FIG. 5. The deal may be a generic deal that is not user specific. For example, a coupon with a discount on purchases during an off-peak window may be part of the deal. Alternatively, the deal may be targeted to a user, for example, based on the customer profile if the user is an existing customer. For example, if a particular user is determined to have always bought items with free shipping, then the deal may be targeted to that particular user by offering free shipping for qualifying purchases during an off-peak window. For instance, the qualifying purchases may be those with a total order price over a certain amount.

Once the off-peak window(s) and deal(s) have been determined, the deal(s) to move to the off-peak window(s) is (are) presented (410) to at least some of the current (peak-time) users. In an implementation, the presentation of the deals may be accomplished by way of a pop-up window with the deal and (off-peak) time period information. In another implementation, the presentation of the deals may be accomplished by way of integrating the deal and time period information into the web pages served to the users. The current users are then able to view the incentive deals, and as a result, a fraction of the current users should decide to switch (412) to the off-peak time to use the website or to make a purchase from the website.

FIG. 5 is a flow chart depicting a method 500 of targeting an incentive deal in accordance with an embodiment of the invention. A determination (502) is made as to whether the user is an existing customer. In other words, it is determined as to whether information on the user is present in an existing customer database 212. If the user is not an existing customer, then a deal designated for new customers or a default deal may be selected (504).

If the user is an existing customer, then the customer profile for that user is retrieved (506), for example, from a customer profile database 212. Based at least in part on the customer profile, a deal for that user may then be selected (508). For example, the customer may have recently purchased a camera from this site, and a coupon giving a discount on a related product (such as, flash memory for the camera) may be presented with a limited time period for use during the off-peak window or windows. As another example, the customer profile may indicate that the customer usually makes purchases when free shipping is offered, and so the deal offered may be free shipping for purchases made during the off-peak window or windows.

In embodiments of the invention, one or more of the above-discussed methods may be implemented using software or computer-executable code. Such code may be executed, for example, by processor(s) in the server(s) 206 of the system 200. The code may be stored on computer-readable media, such as, for example, a hard disk or other data storage accessible by the processor(s) of the server(s) 206.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of relieving pressure during peak-usage times of an online system, the method comprising:
monitoring current usage of a server of the system;
determining if the current usage is above a pre-determined threshold level; and
if the usage is above the threshold level, then providing an offer to a current user with an incentive to use the system during a future off-peak window.

2. The method of claim 1, wherein the off-peak window is predicted by analyzing historical usage data.

3. The method of claim 1, wherein multiple off-peak windows are presented to the current user.

4. The method of claim 1, wherein the current user is an existing customer, and wherein the off-peak window presented is targeted to the current user using previous activity by the current user.

5. The method of claim 1, wherein the current user is an existing customer, and wherein the offer is targeted to the current user based on a stored customer profile for the current user.

6. The method of claim 1, wherein the offer comprises a discount on a purchase during the off-peak window.

7. The method of claim 1, wherein the offer comprises free shipping on qualifying purchases during the off-peak window.

8. The method of claim 1, wherein the future off-peak window comprises a time slot later in a current day, wherein the time slot is predicted to have less user-traffic.

9. The method of claim 1, wherein the future off-peak window comprises a later day predicted to have less user-traffic.

10. A system of relieving pressure during peak-usage times of a web site, the system comprising:
at least one server configured to host the web site;
a historical usage database coupled to the server and used for determining future off-peak windows;
computer-executable code configured to monitor current usage of the web site and to determine if the current usage is above a pre-determined threshold level; and
computer-executable code configured to present an offer to a current user with an incentive to use the system during a future off-peak window if the current usage is above the threshold level.

11. The system of claim 10, further comprising:
a customer profile database coupled to the server,
wherein the current user is an existing customer with a profile in the database, and
wherein the off-peak window presented is targeted to the current user using data in the profile relating to previous activity by the current user.

12. The system of claim 10, further comprising:
a customer profile database coupled to the server,
wherein the current user is an existing customer with a profile in the database,
and wherein the offer is targeted to the current user based on the profile.

13. The system of claim 10, wherein the offer comprises a discount on a purchase during the off-peak window.

14. The system of claim 10, wherein the offer comprises free shipping on qualifying purchases during the off-peak window.

15. The system of claim 10, wherein the future off-peak window comprises a time slot later in a current day, wherein the time slot is predicted to have less user-traffic.

16. The system of claim 10, wherein the future off-peak window comprises a later day predicted to have less user-traffic by an analysis of data in the historical usage database.

17. A computer-readable medium having computer-executable code thereon which is configured to perform a method for relieving pressure during peak-usage times of an online system comprising:
determining current usage of a server of the system;
checking if the current usage is above a pre-determined threshold level; and
if the usage is above the threshold level, then generating an offer to send to a current user with an incentive to use the system during a future off-peak window.

18. The computer-readable medium of claim 17, wherein the off-peak window is predicted by analyzing historical usage data.

19. The computer-readable medium of claim 17, wherein the current user is an existing customer, and wherein the off-peak window for the offer is targeted to the current user using previous activity by the current user.

20. The computer-readable medium of claim 17, wherein the current user is an existing customer, and wherein the incentive for the offer is targeted to the current user based on a stored customer profile for the current user.
